(19) United States
(12) Patent Application Publication
(10) Pub. No.: US 2015/0034319 A1
(43) Pub. Date: Feb. 5, 2015

(54) H2S SCAVENGERS WITH SYNERGISTIC CORROSION INHIBITION

(71) Applicant: BAKER HUGHES INCORPORATED, HOUSTON, TX (US)

(72) Inventor: Grahame N. Taylor, Tomball, TX (US)

(73) Assignee: BAKER HUGHES INCORPORATED, HOUSTON, TX (US)

(21) Appl. No.: 14/322,340

(22) Filed: Jul. 2, 2014

Related U.S. Application Data
(60) Provisional application No. 61/860,524, filed on Jul. 31, 2013.

(51) Int. Cl. C10G 75/02; C09K 8/54

(52) U.S. Cl. CPC C10G 75/02; C09K 8/54; C09K 2208/32
USPC 166/300; 44/334

(57) ABSTRACT

Triazine hydrogen sulfide (H₂S) scavengers consume H₂S and form dithiazines by-products which are corrosion inhibitors. Triazine H₂S scavengers may be formulated with other corrosion inhibitors and used in H₂S-containing fluids so that the dithiazine by-products may together with the at least one additional corrosion inhibitor form give synergistically better inhibiting of corrosion of iron and/or iron alloys in contact with the fluid to an extent greater than additive of the corrosion inhibition of the dithiazine and the corrosion inhibition of the at least one additional corrosion inhibitor, taken separately. The dithiazine may have the formula:

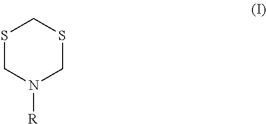

where R is selected from the group consisting of a C₁ to C₁₀ saturated or unsaturated hydrocarbyl group or a C₁ to C₁₀ ω-hydroxy saturated or unsaturated hydrocarbyl group.

### CROSS-REFERENCE TO RELATED APPLICATION

This application claims the benefit of U.S. Provisional Patent Application Ser. No. 61/860,524 filed Jul. 31, 2013, which is incorporated herein by reference in its entirety.

### TECHNICAL FIELD

The present invention relates to methods of inhibiting corrosion of metallic surfaces during treatment of an oil or gas well by introducing into the oil or gas well a dithiazine, and more particularly relates in one non-limiting embodiment to inhibiting the corrosion of iron and/or iron alloys by introducing into the oil or gas well a dithiazine by-product of the reaction of a triazine with hydrogen sulfide (H₂S).

### TECHNICAL BACKGROUND

During the production life of an oil or gas well, the production zone within the well is typically subjected to numerous treatments. Corrosion of metallic surfaces, such as downhole tubulars, during such treatments is not uncommon and is evidenced by surface pitting, localized corrosion and loss of metal. Metallic surfaces subject to such corrosion are carbon steels, ferritic alloy steels, and high alloy steels including chrome steels, duplex steels, stainless steels, martensitic alloy steels, austenitic stainless steels, precipitation-hardened stainless steels and high nickel content steels.

Additionally, aqueous fluids, such as those used in drilling and completion, have a high salt content which causes corrosion. Gases, such as carbon dioxide and hydrogen sulfide, also generate highly acidic environments to which metallic surfaces become exposed. For instance, corrosion effects from brine and hydrogen sulfide are seen in flow lines during the processing of gas streams. The presence of methanol, often added to such streams to prevent the formation of undesirable hydrates, further often increases the corrosion tendencies of metallic surfaces.

Further, naturally occurring and synthetic gases are often conditioned by treatment with absorbing acidic gases, carbon dioxide, hydrogen sulfide and hydrogen cyanide. Degradation of the absorbent and acidic components as well as the generation of by-products (from reaction of the acidic components with the absorbent) results in corrosion of metallic surfaces.

On occasion, a component within a H₂S scavenger may be corrosive. An example of this is glyoxal.

The use of corrosion inhibitors during well treatments to prevent or inhibit the rate of corrosion on metal components and to protect wellbore tubular goods is well known. Commercial corrosion inhibitors are usually reaction mixtures or blends that contain at least one component selected from nitrogenous compounds, such as amines, acetylenic alcohols, mutual solvents and/or alcohols, surfactants, heavy oil derivatives and inorganic and/or organic metal salts.

Many conventional corrosion inhibitors used to reduce the rate of acid attack on metallic surfaces and to protect the tubular goods of the wellbore are becoming unacceptable in oilfield treatment processes. For instance, many conventional corrosion inhibitors have become unacceptable due to environmental protection measures that have been undertaken. In some instances, such as in stimulation processes requiring strong acids, high temperatures, long duration jobs and/or special alloys, the cost of corrosion inhibitors may be so high that it becomes a significant portion of total costs.

It would be desirable to find alternative corrosion inhibitors which are cost effective and which are capable of controlling, reducing or inhibiting corrosion.

### SUMMARY

There is provided, in one non-limiting form, a method for scavenging hydrogen sulfide (H₂S) from and providing corrosion inhibition to a fluid in contact with iron and/or iron alloys. The method includes introducing to a H₂S-containing fluid in any order a triazine and at least one additional corrosion inhibitor. The triazine is one that reacts with H₂S to form a dithiazine capable of and in an amount effective for inhibiting corrosion in the fluid. The at least one additional corrosion inhibitor is one capable of and in an amount effective for inhibiting corrosion in the fluid. The method further comprises at least partially reacting the triazine with H₂S forming the dithiazine, and also contacting the dithiazine with the at least one additional corrosion inhibitor. The method additionally involves inhibiting corrosion of iron and/or iron alloys in contact with the fluid to an extent greater than additive of the corrosion inhibition of the dithiazine and the corrosion inhibition of the at least one additional corrosion inhibitor, taken separately.

### BRIEF DESCRIPTION OF THE DRAWINGS

In order to more fully understand the drawings referred to in the detailed description herein, a brief description of the drawings is presented, in which:

FIGS. 1-7 demonstrate the effectiveness as whole spent fluids (WSF), formulated with additives defined herein.

### DETAILED DESCRIPTION

In circumstances where it is not essential to eliminate any nitrogen-based or triazine H₂S scavenger, it has been discovered that there is inherent value in making a triazine H₂S scavenger part of the formulation, for instance a monoethanolamine (MEA)-triazine, in one non-limiting example. As it consumes H₂S, the MEA-triazine produces an exclusive by-product, 5-hydroxyethyl dithiazine. This is a known effective corrosion inhibitor. Further it has been discovered that the dithiazine can very successfully be synergistically formulated with other conventional corrosion inhibitor intermediates, such as an alkyl pyridine quaternary or “quat” (APQ), in one non-restrictive version, to give an order of magnitude improvement in the corrosion inhibition over and above the use of dithiazine alone.

Thus, if MEA-triazine is included in an H₂S scavenger, along with a synergistic intermediate such as APQ, the scavenger essentially becomes what may be described as “self-inhibiting”; in other words, as the triazine is converted into dithiazine, it combines with the APQ (again, as a non-limiting example) and produces a highly effective corrosion inhibitor, internal to the product, without further addition. This method is far more effective than simply relying on the dithiazine itself, due to the interaction between the dithiazine and at least one additional corrosion inhibitor, in this non-restrictive case, APQ.

More specifically, corrosion is inhibited or prevented during the treatment of a subterranean formation which is penetrated by an oil, gas or geothermal well by forming in a well a dithiazine of the formula:

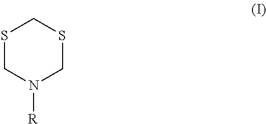

where R is selected from the group consisting of a C₁ to C₁₀ saturated or unsaturated hydrocarbyl group or a C₁ to C₁₀ ω-hydroxy saturated or unsaturated hydrocarbyl group. In one non-limiting embodiment, R is —R¹—OH, where R¹ is an alkylene group, alternatively a C₁-C₆ alkylene group, in another non-limiting embodiment —CH₂CH₂—.

The amount of dithiazine introduced into the well, or produced or made within the well, is an amount sufficient to inhibit corrosion of the base materials, especially iron, of tubulars in the well. It will be appreciated that the methods described herein will be considered successful if corrosion is inhibited, although not necessarily entirely prevented. While complete corrosion prevention is a worthwhile goal, it is not required for success of the invention.

In one non-limiting embodiment, the dithiazine may be that obtained from the homogeneous fluid which is produced during a hydrogen sulfide scavenger gas scrubbing or removal operation. In such scrubbing operations, a scavenger is introduced to a stream of liquid hydrocarbons or natural gas (i.e. sour gas) which contains hydrogen sulfide. In addition, such gas scrubbing operations remove hydrogen sulfide from oil production streams as well as petroleum contained in storage tanks, vessels, pipelines, etc. The scavenger may be an oil soluble triazine known in the art. The production of dithiazines during a scrubbing operation using a triazine as scavenger was reported in U.S. Pat. No. 5,674,377. Typically, dithiazines remain part of the whole spent fluid resulting from the scrubbing operation. Whole spent fluid is typically discarded.

In the method described herein, the dithiazine resulting from the scrubbing operation may be retained in or introduced into a gas, oil or geothermal well where it functions as a corrosion inhibitor. The whole spent fluid may be retained in or introduced to the well or the dithiazine may be produced or generated specifically for the methods described herein.

The dithiazine may be produced or generated as a component of an aqueous treatment fluid into the well. The fluid may be water such as fresh water, brackish water, brine as well as salt-containing water solutions such as sodium chloride, potassium chloride and ammonium chloride solutions.

In one non-limiting embodiment, dithiazine (either specifically produced or generated dithiazine or whole spent fluid) may be introduced into a wellbore fluid formulated with at least one other component selected from the groups:
(a) an alkyl, alkylaryl or arylamine quaternary salt with an alkyl or alkylaryl halide;
(b) a mono or polycyclic aromatic amine salt with an alkyl or alkylaryl halide;
(c) an imidazoline derivative or a quaternary salt thereof formed with an alkyl or alkylaryl halide;
(d) a mono-, di- or trialkyl or alkylaryl phosphate ester; a phosphate ester of hydroxylamines; and phosphate esters of polyols; or
(e) a monomeric or oligomeric fatty acid.

When formulated, the volume ratio of dithiazine to the additive component may be between from about 1:0.5 independently to about 1:2.0; alternatively between from about 1:0.8 independently to about 1:1. As used herein with respect to a range, the word “independently” means that any lower threshold may be used together with any upper range to form a suitable alternative threshold. The dithiazine is formulated with the additive by adding the additive to the whole spent fluid or by adding the additive to an aqueous solution containing the dithiazine. In one non-limiting embodiment, the amount of dithiazine in the fluid ranges from about 1 independently to about 50 mass %; alternatively from about 1 to about 25 mass %. The amount of additive component may range from about 50 independently to about 1 mass %; alternatively from about 50 to about 5 mass %. In one particular non-limiting embodiment, the dithiazine is generated in situ by reacting a triazine with H₂S in the fluid so that H₂S scavenging in the fluid is immediately followed by synergistic corrosion inhibition.

Exemplary of the alkyl, alkylaryl or arylamine quaternary salts with an alkyl or alkylaryl halide are those alkylaryl and arylamine quaternary salts of the formula [N⁺R¹R²R³R⁴][X⁻] wherein R1, R², R³ and R⁴ are hydroxylalkyl, alkyl, alkylaryl, and/or arylalkyl groups containing one to 18 carbon atoms, X is Cl, Br or I; the alkyl or alkylaryl halide containing between from 1 to about 18 carbon atoms. In one non-limiting embodiment, any or all of the R¹, R², R³ and R⁴ are a C₁-C₆ alkyl group or a hydroxyalkyl group wherein the alkyl group is acceptably a C₁-C₆ alkyl or an alkyl aryl such as benzyl. The mono or polycyclic aromatic amine salt with an alkyl or alkylaryl halide include salts of the formula [N⁺R¹R²R³R⁴][X⁻] wherein R1, R², R³ and R⁴ contain one to 18 carbon atoms, and X is Cl, Br or I.

Typical quaternary ammonium salts include, but are not necessarily limited to, tetramethyl ammonium chloride, tetraethyl ammonium chloride, tetrapropyl ammonium chloride, tetrabutyl ammonium chloride, tetrahexyl ammonium chloride, tetraoctyl ammonium chloride, benzyltrimethyl ammonium chloride, benzyltriethyl ammonium chloride, phenyltrimethyl ammonium chloride, phenyltriethyl ammonium chloride, cetyl benzyldimethyl ammonium chloride, and hexadecyl trimethyl ammonium chloride. Particularly suitable quaternary ammonium salts include, but are not necessarily limited to, alkylamine benzyl quaternary ammonium salts, benzyl triethanolamine quaternary ammonium salts and benzyl dimethylaminoethanolamine quaternary ammonium salts.

In addition, the salt may be a quaternary ammonium or alkyl pyridinium quaternary salt such as those represented by the general formula:

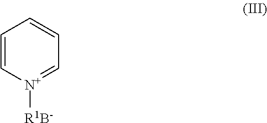

wherein R¹ is an alkyl group, an aryl group or an alkyl group having from 1 to about 18 carbon atoms and B is chloride, bromide or iodide. Suitable compounds include, but are not necessarily limited to, alkyl pyridinium salts and alkyl pyridinium benzyl quats. Exemplary compounds include methyl pyridinium chloride, ethyl pyridinium chloride; propyl pyridinium chloride, butyl pyridinium chloride, octyl pyridinium chloride, decyl pyridinium chloride, lauryl pyridinium chloride, cetyl pyridinium chloride, benzyl pyridinium and an alkyl benzyl pyridinium chloride. It is particularly suitable where the alkyl is a C₁-C₆ hydrocarbyl group.

The additive may further be an imidazoline derived from a diamine such as, but not necessarily limited to, ethylene diamine (EDA), diethylene triamine (DETA), triethylene tetramine (TETA) etc. and a long chain fatty acid such as tall oil fatty acid (TOFA). Suitable imidazolines include those of formula (IV):

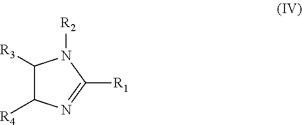

wherein R³ and R⁴ are independently a C₁-C₆ alkyl group, suitably, but not necessarily limited to, hydrido, R² is hydrido and R¹ a C₁-C₂₀ alkyl, a C₁-C₂₀ alkoxyalkyl group. In one non-restrictive embodiment, R², R³ and R⁴ are each hydrido and R¹ is the alkyl mixture typical in tall oil fatty acid (TOFA).

Suitable mono-, di- and trialkyl as well as alkylaryl phosphate esters and phosphate esters of mono, di, and triethanolamine typically contain between from 1 to about 18 carbon atoms. Alternatively, suitable mono-, di- and trialkyl phosphate esters and alkylaryl phosphate esters are those prepared by reacting a C₃₋₁₈ aliphatic alcohol with phosphorous pentoxide. The phosphate intermediate interchanges its ester groups with triethyl phosphate with triethylphosphate producing a more broad distribution of alkyl phosphate esters. Also alternatively, the phosphate ester may be made by admixing with an alkyl diester, a mixture of low molecular weight alkyl alcohols or diols. The low molecular weight alkyl alcohols or diols may include, but are not necessarily limited to, C₆ to C₁₀ alcohols or diols. Further, phosphate esters of polyols and their salts containing one or more 2-hydroxyethyl groups, and hydroxylamine phosphate esters obtained by reacting polyphosphoric acid or phosphorus pentoxide with hydroxylamines such as diethanolamine or triethanolamine are found to be particularly suitable.

The additional corrosion inhibitor may further be a monomeric or oligomeric fatty acid. Suitable oligomeric fatty acids include, but are not necessarily limited to, C₁₄-C₂₂ saturated and unsaturated fatty acids as well as dimer, trimer and oligomer products obtained by polymerizing one or more of such fatty acids.

The amount of dithiazine typically introduced into a well may be in the range of from about 0.05% independently to about 5% by mass of the treatment fluid introduced.

Since the combination of the dithiazine and additional corrosion inhibitor synergistically and dramatically reduces corrosion on metal, it may be used in a variety of industrial applications. And since the combination of dithiazine and at least one additional corrosion inhibitor has particular applicability in well stimulation processes, such as, acidizing and fracture acidizing, it may be introduced into the well during stimulation. Alternatively, the combination of a dithiazine and an additional corrosion inhibitor may be introduced prior to, subsequent to or during a well treatment which produces or involves acid.

Other embodiments within the scope of the claims herein will be apparent to one skilled in the art from consideration of the description set forth herein. It is intended that the specification, together with the examples, be considered exemplary only, with the scope and spirit of the invention being indicated by the claims which follow.

The following examples are illustrative of some of the embodiments of the present invention.

All percentages set forth in the Examples are given in terms of weight units except as may otherwise be indicated.

### Examples

The dithiazine refers to 5-hydroxyethyl-hexahydro-1,3,5-dithiazine of the formula I wherein R is —CH₂CH₂—OH.

Unspent fluid (“UF”) refers to the hexahydro-1,3,5-tri(hydroxyethyl)-s-triazine of the formula II wherein each R is —CH₂CH₂—OH prior to any spending with hydrogen sulfide.

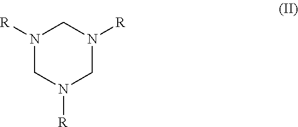

Whole spent fluid (“WSF”) refers to the homogeneous fluid produced in a hydrogen sulfide scavenger gas scrubbing operation wherein the tower was charged with a triazine (hexahydro-1,3,5-tri(hydroxyethyl)-s-triazine) containing fluid in water and methanol. The fluid contains a high level of hydrogen sulfide; the dithiazine still being in the WSF.

Isolated dithiazine (“iDTZ”) refers to dithiazine from the WSF that has been separated out of solution in its pure form.

Formulated products were paired using one of the following additives:
Methyl/Ethylpyridinium benzyl quat (APBQ);
Benzyldimethylcocoamine benzyl quat (ABQ);
TOFA DETA Imidazoline derivative (“TDID”);
Benzyl triethanolaminium quat (BTEAQ); and
Benzyl dimethylaminoethanolaminium quat (BDMAEQ).

Formulated WSF refers to the product formed by dissolving the additive in the WSF at a concentration of 12.2 weight percent with methanol at 10 weight percent.

Formulated iDTZ refers to the product prepared by dissolving iDTZ in methanol at a concentration of 9.6 weight percent and then adding to the resultant methanol solution, the additive at a concentration of 19.2 weight percent. This product was then mixed for a brief period while heating to approximately 60° C.

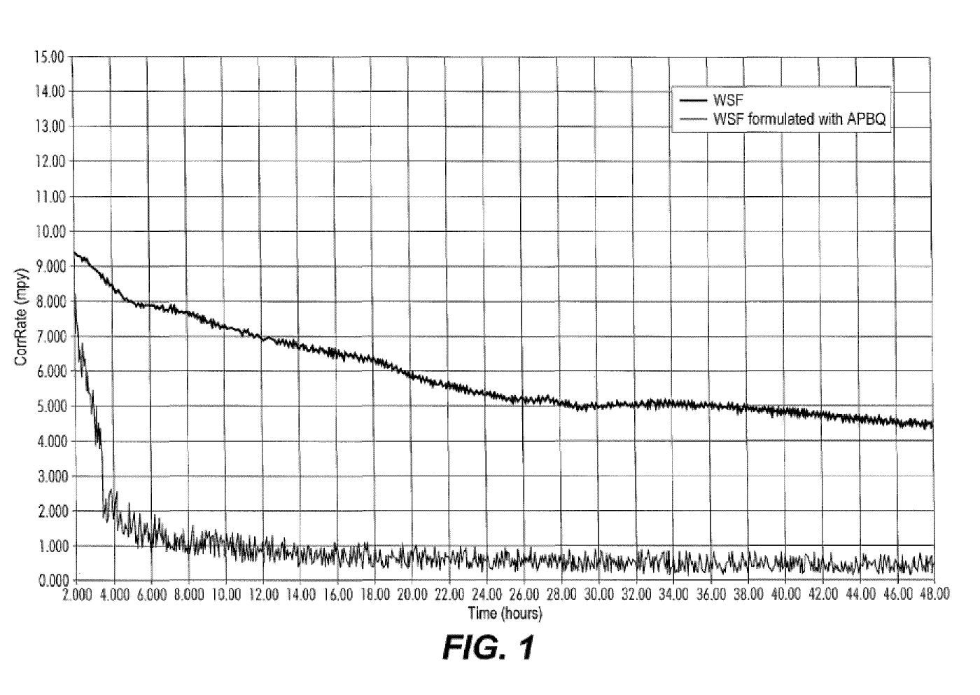

Corrosion rate studies were performed using at ambient temperature a Gamry G Series potentiostat and the conventional Linear Polarization Resistance (LPR) module within the DC105™ corrosion technique software package (Rp/Ec trend). The instantaneous corrosion rate of the three electrode probe system was determined using voltage settings −0.2V to +0.02V versus open-circuit potential, E_{oc}. These studies were carried out during an approximately 20-24 hr run time. The treat rates of the corrosion inhibitors were between 50 and 200 ppm, for the total of the dithiazine and the additional corrosion inhibitor. A standard carbon dioxide saturated brine system comprised of 3 weight percent sodium chloride and 0.3 weight percent calcium chloride in 2 liter corrosion cells sparged with carbon dioxide was employed. LPR scans are shown in FIGS. 1-7.

FIG. 1 contrasts the differences at a treatment rate of 500 ppm in corrosion rates between WSF and formulated WSF containing the additive APBQ. As shown, much higher corrosion rates are demonstrated with formulated WSF than WSF.

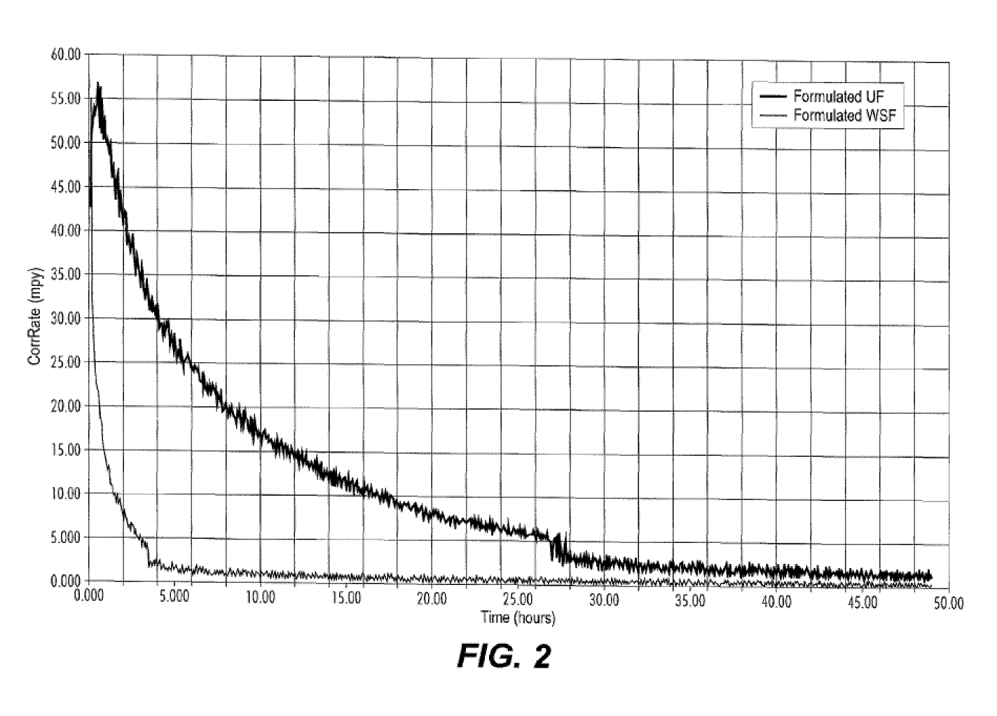

FIG. 2 contrasts the differences at a treatment rate of 500 ppm in corrosion rates between formulated WSF containing the additive APBQ and UF. As shown, formulated WSF is a better corrosion inhibitor than UF.

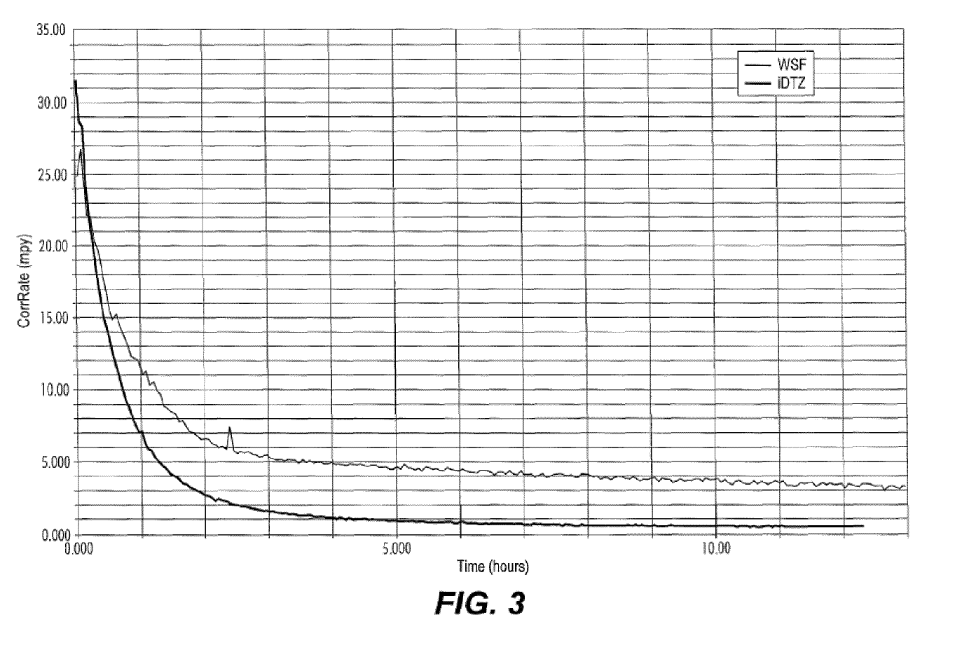

FIG. 3 contrasts the differences at a treatment rate of 430 ppm of WFT and iDTZ. FIG. 3 shows that iDTZ is much more effective than WSF as a corrosion inhibitor.

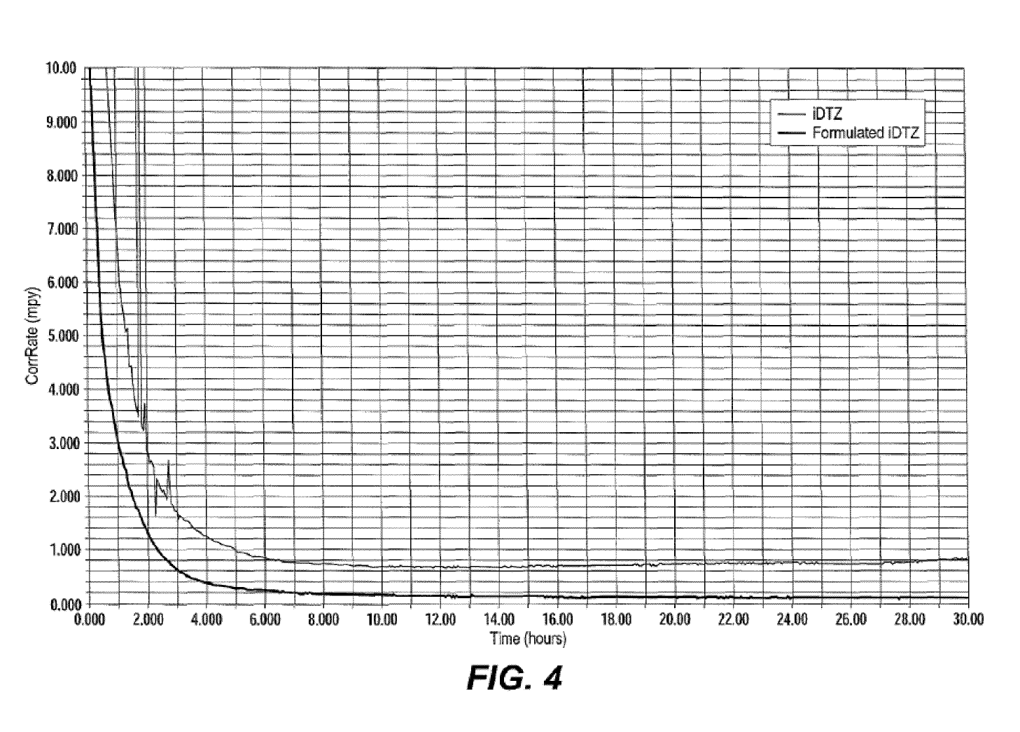

FIG. 4 contrasts the differences at a treatment rate of 430 ppm of Formulated iDTZ (with the additive APBQ) and iDTZ. FIG. 4 shows that Formulated iDTZ is a better corrosion inhibitor than iDTZ.

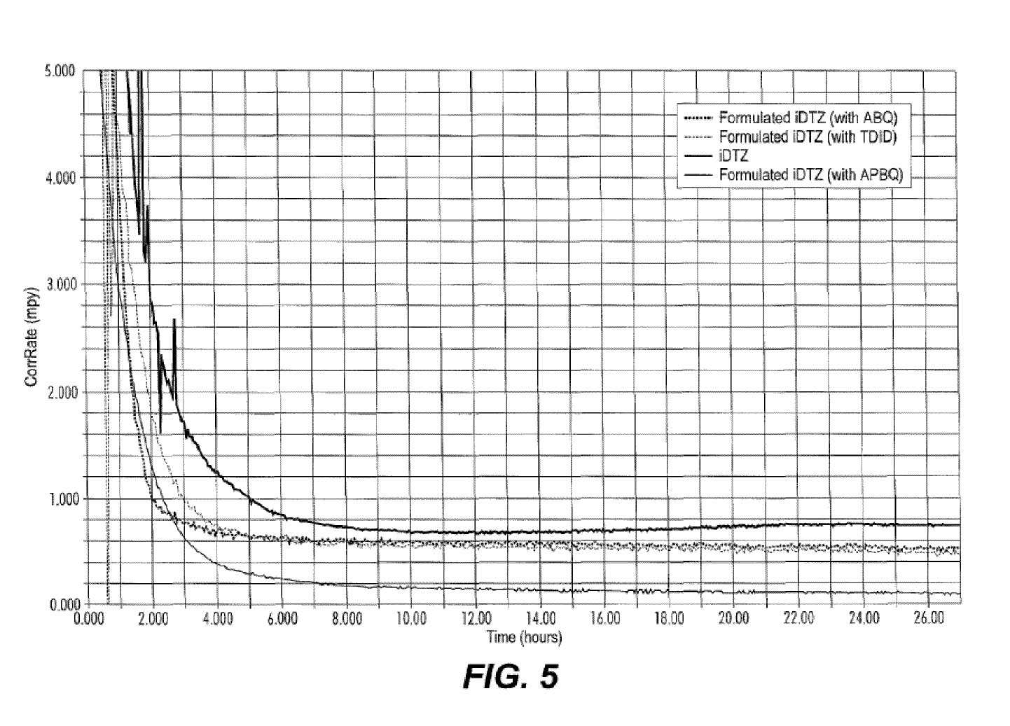

FIG. 5 contrasts the differences at a treatment rate of 430 ppm in corrosion rates between iDTZ and Formulated iDTZ (with the additive ABQ), Formulated iDTZ (with the additive ID) and Formulated iDTZ (with the additive APBQ). FIG. 5 shows the Formulated iDTZ (with APBQ) to be the best corrosion inhibitor. Formulated iDTZ (with ID) and Formulated iDTZ (with ABQ) demonstrate similar results. All of the formulated iDTZs demonstrated better corrosion inhibition than iDTZ.

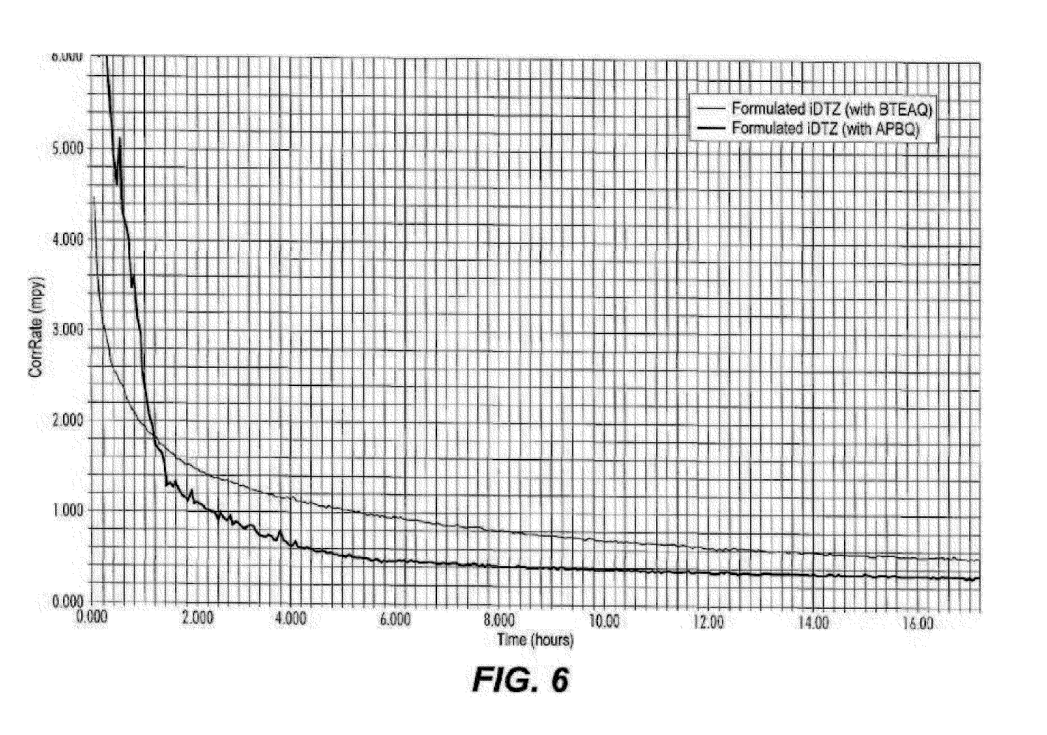

FIG. 6 contrasts the differences at a treatment rate of 125 ppm in corrosion rates between Formulated iDTZ (with BTEAQ) and Formulated iDTZ (with APBQ). FIG. 6 demonstrates between corrosion results with Formulated iDTZ (with APBQ).

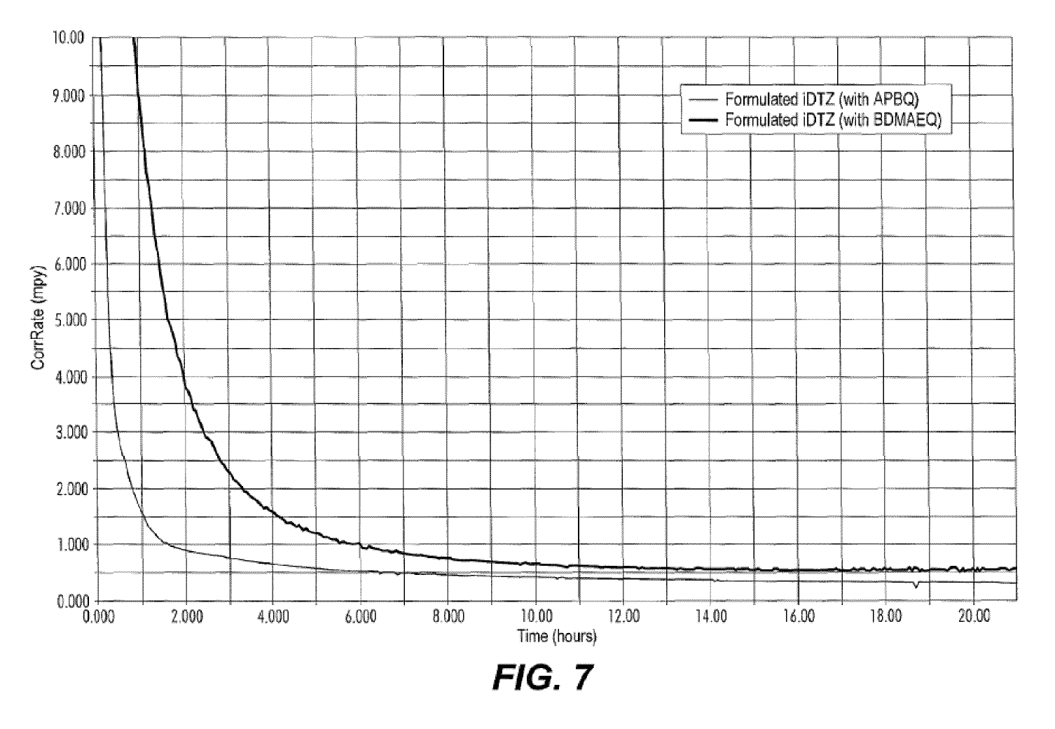

FIG. 7 contrasts the differences at a treatment rate of 125 ppm in corrosion rates between Formulated iDTZ (with APBQ) and Formulated iDTZ (with BDMAEQ). FIG. 7 demonstrates almost the same results between the two formulated products.

These data, Examples and Figures demonstrate that corrosion of iron and/or iron alloys is inhibited in contact with a fluid containing a dithiazine and at least one additional corrosion inhibitor to an extent greater than additive of the corrosion inhibition of the dithiazine and the corrosion inhibition of the at least one additional corrosion inhibitor, taken separately. As previously discussed, the dithiazine is produced or generated in the liquid in situ when a triazine H₂S scavenger reacts with H₂S.

In the foregoing specification, the invention has been described with reference to specific embodiments thereof, and has been demonstrated as effective in providing methods and compositions for synergistically inhibiting corrosion while also scavenging H₂S. While it will be appreciated that the methods and compositions described herein will find particular application and use in wellbores drilled into subterranean reservoirs, and in subterranean formations themselves (particularly the near wellbore part of the formation), the methods and compositions will find utility in other fluids where H₂S is present and corrosion of iron and/or iron alloys in contact with the fluid may occur. However, it will be evident that various modifications and changes can be made thereto without departing from the broader spirit or scope of the invention as set forth in the appended claims. Accordingly, the specification is to be regarded in an illustrative rather than a restrictive sense. For example, specific combinations of triazines, dithiazines, additional corrosion inhibitors, fluids and other components falling within the claimed parameters, but not specifically identified or tried in a particular method or composition, are anticipated to be within the scope of this invention. Furthermore, reaction conditions other than those specifically exemplified herein are expected to be useful for the methods and compositions described herein.

The terms “comprises” and “comprising” used in the claims herein should be interpreted to mean including, but not limited to, the recited elements.

The present invention may suitably comprise, consist or consist essentially of the elements disclosed and may be practiced in the absence of an element not disclosed. For instance, the method for scavenging hydrogen sulfide (H₂S) from and providing corrosion inhibition to a fluid in contact with iron and/or iron alloys may consist of or consist essentially of introducing to a H₂S-containing fluid in any order a triazine and at least one additional corrosion inhibitor. The triazine is one that reacts with H₂S to form a dithiazine capable of and in an amount effective for inhibiting corrosion in the fluid. The at least one additional corrosion inhibitor is capable of and in an amount effective for inhibiting corrosion in the fluid. The method further consists of, or consists essentially of, at least partially reacting the triazine with H₂S forming the dithiazine and contacting the dithiazine with the at least one additional corrosion inhibitor. Finally, the method may consist of, or consist essentially of, inhibiting corrosion of iron and/or iron alloys in contact with the fluid to an extent greater than additive of the corrosion inhibition of the dithiazine and the corrosion inhibition of the at least one additional corrosion inhibitor, taken separately.

What is claimed is:

1. A method for scavenging hydrogen sulfide (H₂S) from and providing corrosion inhibition to a fluid in contact with iron and/or iron alloys comprising:
introducing to a H₂S-containing fluid in any order:
a triazine that reacts with H₂S to form a dithiazine capable of and in an amount effective for inhibiting corrosion in the fluid, and
at least one additional corrosion inhibitor capable of and in an amount effective for inhibiting corrosion in the fluid;
at least partially reacting the triazine with H₂S forming the dithiazine;
contacting the dithiazine with the at least one additional corrosion inhibitor, and
inhibiting corrosion of iron and/or iron alloys in contact with the fluid to an extent greater than additive of the corrosion inhibition of the dithiazine and the corrosion inhibition of the at least one additional corrosion inhibitor, taken separately.

2. The method of claim 1 further comprising introducing the fluid into a wellbore.

3. The method of claim 1 where the dithiazine has the formula: 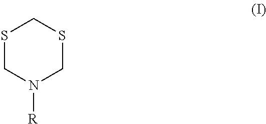
where R is selected from the group consisting of a C₁ to C₁₀ saturated or unsaturated hydrocarbyl group or a C₁ to C₁₀ ω-hydroxy saturated or unsaturated hydrocarbyl group.

4. The method of claim 1 where R is —R¹—OH, where R¹ is an alkylene group.

5. The method of claim 4 where R¹ is an alkylene group of C₁-C₆.

6. The method of claim 1 where the at least one additional corrosion inhibitor is selected from the group consisting of:
(a) an alkyl, alkylaryl or arylamine quaternary salt with an alkyl or alkylaryl halide;
(b) a mono or polycyclic aromatic amine salt with an alkyl or alkylaryl halide;
(c) an imidazoline derivative or a quaternary salt thereof formed with an alkyl or alkylaryl halide;
(d) a mono-, di- or trialkyl or alkylaryl phosphate ester; and
(e) a monomeric or oligomeric fatty acid.

7. The method of claim 6, where the at least one additional corrosion inhibitor is an alkyl, alkylaryl or arylamine quaternary salt with an alkyl or alkylaryl halide.

8. The method of claim 7, where the quaternary salt of the at least one additional corrosion inhibitor has the formula [N⁺R¹R²R³R⁴][X⁻] wherein each of R¹, R², R³ and R⁴ independently contains 1 to 18 carbon atoms, X is selected from the group consisting of Cl, Br and I, and the alkyl or alkylaryl halide contains between from 1 to about 18 carbon atoms.

9. The method of claim 8, where at least one of R¹, R², R³ and R⁴ is a C₁-C₆ alkyl group or a hydroxyalkyl group wherein the alkyl group is a C₁-C₆ alkyl or an alkyl aryl.

10. The method of claim 6, where the at least one additional corrosion inhibitor is a mono or polycyclic aromatic amine salt with an alkyl or alkylaryl halide.

11. The method of claim 10, where the salt has the formula [N⁺R¹R²R³R⁴][X⁻] where R¹, R², R³ and R⁴ independently contain from 1 to about 18 carbon atoms and X is selected from the group consisting of Cl, Br and I.

12. The method of claim 11, where R¹, R², R³ and R⁴ are independently selected from the group consisting of a C₁-C₆ alkyl group, a C₁-C₆ hydroxyalkyl group, and an alkyl aryl group where the alkyl group is a C₁-C₆ alkyl.

13. The method of claim 6, where the at least one additional corrosion inhibitor is selected from the group consisting of alkylamine benzyl quaternary ammonium salts, benzyl triethanolamine quaternary ammonium salts and benzyl dimethylaminoethanolamine quaternary ammonium salts.

14. The method of claim 6, where the at least one additional corrosion inhibitor is a quaternary ammonium or alkyl pyridinium quaternary salt of the formula: 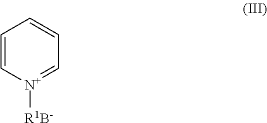
where R¹ is an alkyl group or an aryl group having from 1 to about 18 carbon atoms and B is chloride, bromide or iodide.

15. The method of claim 1 where the triazine has the formula selected from the group consisting of: 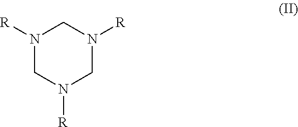
where R is selected from the group consisting of a C₁ to C₁₀ saturated or unsaturated hydrocarbyl group and a C₁ to C₁₀ ω-hydroxy saturated or unsaturated hydrocarbyl group.

16. The method of claim 2 where the fluid is introduced into the wellbore during stimulation.

17. The method of claim 1 where the volume ratio of dithiazine to the additional corrosion inhibitor ranges between about 1:05 to about 1:2.0.

18. The method of claim 1 where the amount of dithiazine in the fluid ranges from about 1 to about 25 mass % and the amount of the at least one additional corrosion inhibitor ranges from about 5 to about 50 mass %.

19. A method for scavenging hydrogen sulfide (H₂S) from and providing corrosion inhibition to a fluid in contact with iron and/or iron alloys comprising:
introducing to a H₂S-containing fluid in any order:
a triazine that reacts with H₂S to form a dithiazine capable of and in an amount effective for inhibiting corrosion in the fluid, and
at least one additional corrosion inhibitor capable of and in an amount effective for inhibiting corrosion in the fluid, the at least one additional corrosion inhibitor selected from the group consisting of:
(a) an alkyl, alkylaryl or arylamine quaternary salt with an alkyl or alkylaryl halide;
(b) a mono or polycyclic aromatic amine salt with an alkyl or alkylaryl halide;
(c) an imidazoline derivative or a quaternary salt thereof formed with an alkyl or alkylaryl halide;
(d) a mono-, di- or trialkyl or alkylaryl phosphate ester; and
(e) a monomeric or oligomeric fatty acid;
where the H₂S-containing fluid is in a wellbore;
at least partially reacting the triazine with H₂S forming the dithiazine;
contacting the dithiazine with the at least one additional corrosion inhibitor, and
inhibiting corrosion of iron and/or iron alloys in contact with the fluid to an extent greater than additive of the corrosion inhibition of the dithiazine and the corrosion inhibition of the at least one additional corrosion inhibitor, taken separately.

20. A method for scavenging hydrogen sulfide (H₂S) from and providing corrosion inhibition to a fluid in contact with iron and/or iron alloys comprising:
introducing to a H₂S-containing fluid in any order:
a triazine that reacts with H₂S to form a dithiazine capable of and in an amount effective for inhibiting corrosion in the fluid, and
at least one additional corrosion inhibitor capable of and in an amount effective for inhibiting corrosion in the fluid, the at least one additional corrosion inhibitor selected from the group consisting of:
(a) an alkyl, alkylaryl or arylamine quaternary salt with an alkyl or alkylaryl halide;
(b) a mono or polycyclic aromatic amine salt with an alkyl or alkylaryl halide;
(c) an imidazoline derivative or a quaternary salt thereof formed with an alkyl or alkylaryl halide;
(d) a mono-, di- or trialkyl or alkylaryl phosphate ester; and
(e) a monomeric or oligomeric fatty acid;
at least partially reacting the triazine with H₂S forming the dithiazine, where the dithiazine has the formula: 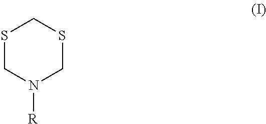
where R is selected from the group consisting of a C₁ to C₁₀ saturated or unsaturated hydrocarbyl group or a C₁ to C₁₀ ω-hydroxy saturated or unsaturated hydrocarbyl group;
contacting the dithiazine with the at least one additional corrosion inhibitor, and
inhibiting corrosion of iron and/or iron alloys in contact with the fluid to an extent greater than additive of the corrosion inhibition of the dithiazine and the corrosion inhibition of the at least one additional corrosion inhibitor, taken separately.
